(19) United States
(12) Patent Application Publication
(10) Pub. No.: US 2024/0413301 A1
(43) Pub. Date: Dec. 12, 2024

(54) AEROSOL JET PRINTABLE SOLID POLYMER ELECTROLYTE

(71) Applicant: Government of the United States as represented by the Secretary of the Air Force, Wright-Patterson AFB, OH (US)

(72) Inventors: Joseph P. Fellner, Kettering, OH (US); Yu Zhu, Akron, OH (US); Lazarus J. Deiner, Brooklyn, NY (US)

(21) Appl. No.: 18/650,519

(22) Filed: Apr. 30, 2024

Related U.S. Application Data
(60) Provisional application No. 63/471,533, filed on Jun. 7, 2023.

(51) Int. Cl. H01M 4/1391; B41M 3/00; B41M 5/00; B41M 7/00; H01M 4/04; H01M 10/0525; H01M 10/0565

(52) U.S. Cl. CPC H01M 4/1391; B41M 3/008; B41M 5/0011; B41M 5/0058; B41M 7/0081; H01M 4/0404; H01M 4/0435; H01M 10/0525; H01M 10/0565; H01M 2300/0082

(57) ABSTRACT

The present invention relates to a method to print all-solid-state batteries using aerosol jet printing technology. The method yields an improved solid-state lithium battery comprising a solvent free deposition of solid polymer electrolyte on top of printed cathode that provides tunable penetration into cathode without throughput or processing limitations of solution deposition and post-deposition UV cross linking that provides improved strength of the battery's relatively thin electrolyte films. The improved solid-state lithium battery exhibits a capacity that is significantly greater than previous solid-state lithium batteries at temperatures below 60° C., at rates of greater than C/3 with improved stability.

### CROSS-REFERENCE TO RELATED APPLICATION

The present application claims priority to U.S. Provisional Application Ser. No. 63/471,533 filed Jun. 7, 2023, the contents of such priority document being hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to an improved all-solid-state battery and method to print all-solid-state batteries using aerosol jet printing technology.

### BACKGROUND OF THE INVENTION

Solid-state lithium batteries have gained considerable interest as a next generation high energy-dense electrochemical power source. They offer not only the potential for high energy densities but also safe operation as compared to state-of-the-art Li-ion battery technology. However, the performance of these batteries falls drastically short of the potential theoretical values in practice due to limitations in cathode diffusion/reaction kinetics and instability/decreased conductivity issues in the electrolyte. One of the most challenging issues in solid-state batteries (SSB) is the high interfacial charge transfer resistance between the porous electrodes and electrolyte. Two additional serious challenges of solid-state lithium batteries is limited ionic transport through the cathode and the difficulty of fabricating thin enough electrolyte films.

Applicants recognized that the source of the aforementioned problems was that conventional methods of joining the solid electrolyte layer to the cathode create an interface that is defective on the micron scale, that solid electrolytes do not penetrate into the depth of the cathode so there are no facile channels for lithium ion migration from the depth of the cathode and finally conventional methods of solid electrolyte manufacture create relatively thick films (>30 microns). To solve the issues arising from lack of solid electrolyte penetration, cathode/electrolyte interfacial resistance, and solid electrolyte film thickness, Applicants developed a process of solvent-free aerosol jet printing cross linkable solid polymer electrolytes. The solvent-free aerosol jet printing allows for deposition of electrolyte directly onto a porous cathode. The aerosol droplets readily penetrate into the cathode creating the channels for ion migration through the depth of the cathode. The aerosol jet printing also allows for a seamless, conformal electrode/electrolyte interface, and for control of the solid polymer electrolyte thickness down to arbitrarily thin levels as low as ˜10 microns. Thus, Applicants disclose an improved solid-state lithium battery comprising a solvent free deposition of solid polymer electrolyte on top of printed cathode that provides tunable penetration into cathode, without throughput or processing limitations of solution deposition, and post-deposition UV cross linking that provides improved strength of the battery's relatively thin electrolyte films. Applicants' solid-state lithium battery exhibits a capacity that is significantly greater than previous solid-state lithium batteries at temperatures below 60° C., at rates of greater than C/3 with improved stability.

### SUMMARY OF THE INVENTION

The present invention relates to a method to print all-solid-state batteries using aerosol jet printing technology. The method yields an improved solid-state lithium battery comprising a solvent free deposition of solid polymer electrolyte on top of printed cathode that provides tunable penetration into cathode, without throughput or processing limitations of solution deposition, and post-deposition UV cross linking that provides improved strength of the battery's relatively thin electrolyte films. The improved solid-state lithium battery exhibits a capacity that is significantly greater than previous solid-state lithium batteries at temperatures below 60° C., at rates of greater than C/3 with improved stability.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic of the aerosol jet printer.

FIG. 2 is a block diagram of the printed cathode/electrolyte for use in a membrane-free battery cell.

FIG. 3 is a block diagram of the printed cathode/electrolyte for use in a membrane-supported battery cell.

FIG. 4 is a graph of the wt. % carbon (proxy for polymer) and wt. % P (proxy for cathode material) as a function of depth in the cathode.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Detailed Description of Figures

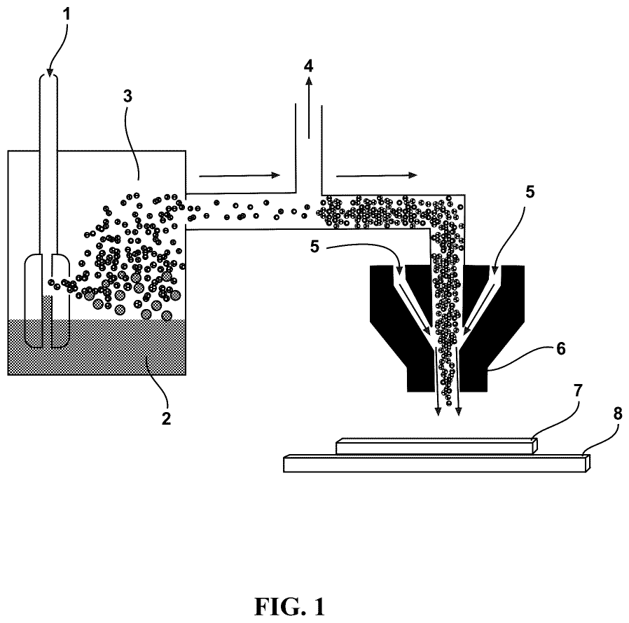

FIG. 1 shows a schematic of the aerosol jet printing process. A high pressure gas enters the aerosol jet atomizer (1). The atomizer has an opening on the bottom to the ink (2) and narrow opening on the side. When the gas flows through the narrow side opening, a region of low pressure is created which causes generation of an aerosol mist from the ink (3). This mist is entrained in a carrier gas, concentrated by removal of excess gas in an exhauster/virtual impactor (4). The mist is then focused by a sheath gas (5) through the deposition head (6). When it exits the deposition head it impinges on a substrate (7) that has been placed on a movable stage (8).

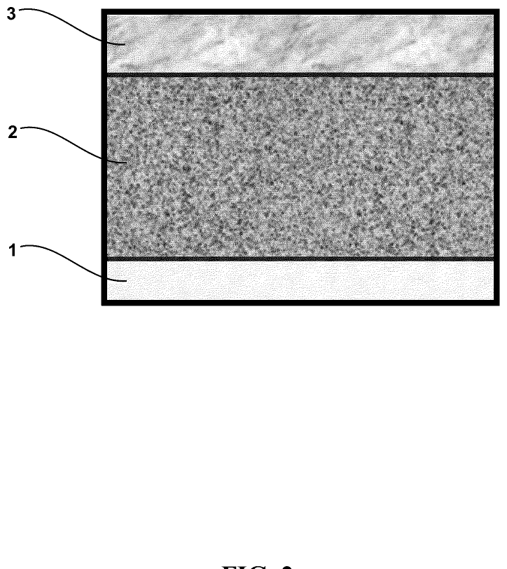

FIG. 2 shows the current collector (1), printed cathode (2), and printed electrolyte (3) layers of the membrane-free all solid state battery.

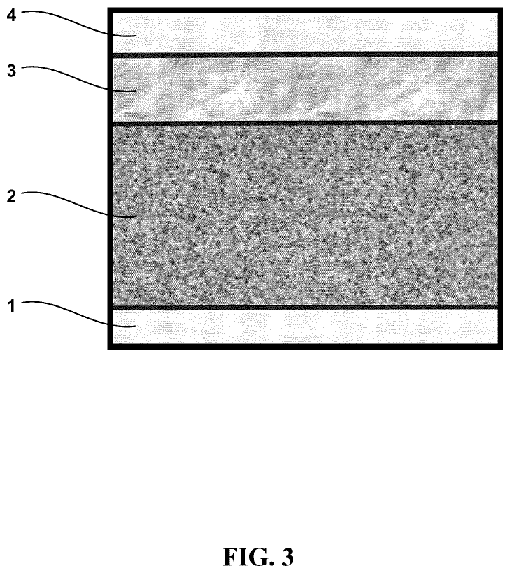

FIG. 3 shows the current collector (1), printed cathode (2), printed electrolyte (3), and conventional separator (4) layers of the membrane-supported all solid state battery.

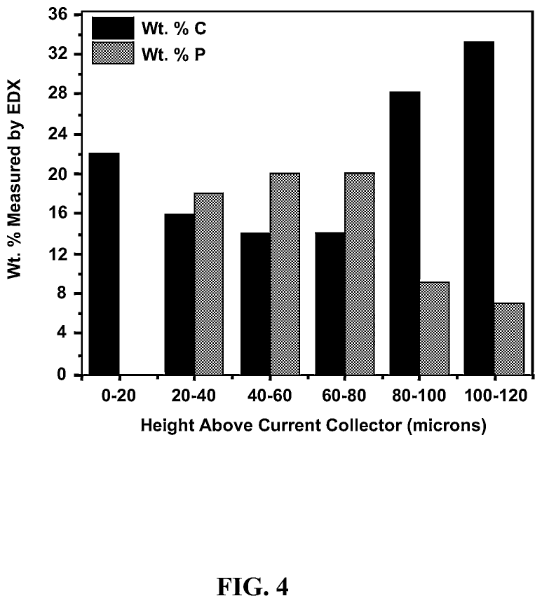

FIG. 4 shows the weight percent of carbon (a proxy for polymer) and phosphorous (a proxy for the LFP material) throughout the depth of the printed composite cathode.

### All-Solid-State Battery and Articles Comprising Same

In this paragraph, Applicants disclose an all-solid-state battery comprising the following sequential layers: a current collector layer, a cathode layer, a solid polymer electrolyte layer and an anode layer, at least a portion of said solid polymer electrolyte extending through said cathode to contact said current collector.

In this paragraph, Applicants disclose the all-solid-state battery of the previous paragraph wherein said solid polymer electrolyte comprises crosslinked polyethylene glycol diacrylate, Bis(trifluoromethylsulfonyl)amine lithium salt, lithium bis(oxalato) borate, succinonitrile, and fluoroethylene carbonate, preferably said solid polymer electrolyte comprises, based on solid polymer electrolyte weight, 19% polyethylene glycol diacrylate, 26% Bis(trifluoromethylsulfonyl) amine lithium salt, 20% lithium bis(oxalato) borate, 30% succinonitrile, and 5% fluroethylene carbonate.

In this paragraph, Applicants disclose the all-solid-state battery of the previous two paragraphs, said all-solid-state battery having, at 30° C. a specific capacity of over 130 mAh/g at 0.05 C and area capacity is 1.37 mAh/cm².

In this paragraph, Applicants disclose the all-solid-state battery of the first and second paragraphs of this section of this specification titled “All-solid-state Battery and Articles Comprising Same”, said all-solid-state battery having, at 60° C. test, reversible specific capacities of 163 mAh/g, 138 mAh/g, 126 mAh/g, 121 mAh/g, and 154 mAh/g at current densities of 0.1 C, 0.3 C, 0.5 C, 1 C, and 0.1 C; and reversible areal capacities of 1.6 mAh/cm², 1.35 mAh/cm², 1.23 mAh/cm², 1.19 mAh/cm² and 1.51 mAh/cm² at current densities of 0.1 C, 0.3 C, 0.5 C, 1 C, and 0.1 C.

In this paragraph, Applicants disclose the all-solid-state battery of the first, second and fourth paragraphs of this section of this specification titled “All-solid-state Battery and Articles Comprising Same”, said all-solid-state battery having, after 150 cycles at 0.3 C at a temperature of 60° C., a capacity retention of 97.4% and 99.98% coulombic efficiency.

In this paragraph, Applicants disclose an article comprising the all-solid-state battery of the previous five paragraphs, said article being a battery energy storage system, an electric vehicle, or a consumer electronic device. A battery energy storage system can include one or more batteries to store energy from renewable or non-renewable sources, and release it when necessary. Electric vehicles can include aircraft, terrestrial vehicles, amphibious vehicles, water surface vehicles, or undersea vehicles. Consumer electronics can include cell phones, computers, computer and cell phone accessories, and wearable devices. Computer and cell phone accessories can include headphones, keyboards, and mice. Wearable devices can include watches and electrified garments.

Method to Print all-Solid-State Batteries Using Aerosol Jet Printing Technology

In this paragraph, Applicants disclose a process of making all-solid-state batteries comprising:
a) making an active material ink, said active ink comprising a dispersion of a cathode active, for example, LiFePO4, a conductive carbon, for example Carbon Super P from MTI, Inc. of Richmond, California USA and a conductive polymer, Kynar 1800 from Arkema of King of Prussia, Pennsylvania USA in a solvent, for example n-methyl-2-pyrrolidone, said of LiFePO4, a conductive carbon and conductive polymer being present, for example, in a weight ratio of 96:2:2, and the weight ratio of LifePO4, a conductive carbon and conductive polymer to solvent weight ratio being for example, 1:3;
b) aerosol jet printing a cathode from an active ink comprising a cathode active, a conductive carbon, a conductive polymer and a solvent, on a conductive substrate said substrate comprising, for example, carbon coated aluminum from MTI, Inc. of Richmond, California USA, said aerosol jet printing being conducted under a dew point of less than −40° C., a printing nozzle distance to said conductive substrate of 10 mm, said conductive substrate being maintained during said aerosol jet printing at a temperature of 50° C. and said active ink being maintained during said aerosol jet printing at a temperature of 21° C., said active ink being deposited on said conductive substrate at a rate of 9 mg/minute, said cathode after said aerosol jet printing having an active ink mass loading of 10 mg/cm²;
c) drying said cathode to remove said active ink solvent, said drying being conducted, for example, at 90° C. for 12 hours;
d) calendaring said cathode to a porosity of 60%;
e) aerosol jet printing a solid polymer electrolyte ink on at least one side of said cathode, said solid polymer electrolyte ink comprising crosslinked polyethylene glycol diacrylate, Bis(trifluoromethylsulfonyl) amine lithium salt, lithium bis(oxalato) borate, succinonitrile, and fluroethylene carbonate, preferably said solid polymer electrolyte comprises, based on solid polymer electrolyte weight, 19% polyethylene glycol diacrylate, 26% Bis(trifluoromethylsulfonyl) amine lithium salt, 20% lithium bis(oxalato) borate, 30% succinonitrile, and 5% fluroethylene carbonate, said aerosol jet printing being conducted under a dew point of less than −40° C., a printing nozzle distance to said conductive substrate of 10 mm, said cathode being maintained during said aerosol jet printing at a temperature of 50° C. and said solid polymer electrolyte ink being maintained during said aerosol jet printing at a temperature of 40° C., said solid polymer electrolyte ink being deposited on said conductive substrate at a rate of 5 mg/minute, said aerosol jet printing comprising 25 aerosol jet printing passes;
e) UV curing said cathode, for example, by exposing said cathode to UV light having a wavelength 320 nm, for 2 minutes; and
f) depositing an anode material on said cathode, preferably said deposition comprises aerosol jet printing said anode on said cathode, preferably said anode material comprises Li, and/or graphite.

Materials that are needed to produce the all-solid-state batteries disclosed and/or claimed by Applicants in this specification can be purchased from companies such as: MTI, inc., Arkema, Sigma Aldrich, and Matrix Scientific. Aerosol jet printing equipment can be purchased from companies such as: Optomec, Inc. and IDS.

### Test Methods

The resistance of the printed solid state batteries was measured using electrochemical impedance spectroscopy (EIS). EIS was conducted to assess the resistance of the battery coin cells. The EIS was conducted in potentiostatic mode. The frequency range was 100 kHz to 0.1 Hz with a perturbation of 10 mV.

### Battery Capacity Test:

1.) Battery Configuration For Testing: Battery electrochemical performance should be tested in two separate coin cell configurations. The first configuration is a composite having the following ordered, sequential layers: current collector, cathode, solid polymer electrolyte and lithium foil anode (250 micron thickness). For the first configuration a coin cell is made as follows: the solid polymer electrolyte, cathode and anode are punched into disks, then placed into a stainless steel coin cell case. A stainless steel spacer and stainless steel spring from MTI, Inc. of Richmond California USA) or equivalent are added on top of the anode, then the coin cell is closed and crimped. The second configuration is a composite having the following ordered, sequential layers: current collector, cathode, solid polymer electrolyte, treated Solupor membrane and lithium foil anode (250 micron thickness). To fabricate the treated Solupor membrane, a Solupor (Lydall, polyethylene membrane with a thickness of 20 μm, porosity of 83%, and Gurley number 1.4 s (50 ml)) membrane should be soaked in initiator-free solid polymer electrolyte precursor (SPE) for 12 hours. Next, the membrane should be soaked in SPE precursor containing a 1 wt % photoinitiator bis(2,4,6-trimethyl benzoyl)-phenyl phosphine oxide (Irgacure® 819, Sigma Aldrich, 97%) for 5 minutes. Then, the soaked membrane should be cross-linked to form a solid film with a thickness of 25 μm. The SPE precursor was prepared by mixing succinonitrile (C₄H₄N₂, TCI, 99%), poly(ethylene glycol) diacrylate (PEGDA, Sigma Aldrich, 99%) with a molecular weight of 700 g/mol, lithium bis(oxalate) borate (LiBOB, SigmaAldrich), lithium bis(trifluoromethanesulphonyl) imide (LiTFSI, Matrix Scientific), and Fluoroethylene carbonate (FEC, Sigma Aldrich 99%). The mass ratio of components in the SPE should be Succinonitrile: PEGDA: LITFSI (40:25:35). LiBOB should be added to the SPE (with the LiTFSI: LiBOB molar ratio 1:0.085) to improve the electrochemical stability and 5 wt % FEC. For the second configuration a coin cell is made as follows: the solid polymer electrolyte, cathode treated Solupor membrane and anode are punched into disks, then placed into a stainless steel coin cell case. A metallic spacer and spring are added on top of the anode, then the coin cell is closed and crimped. For each configuration, the cells are held at 45° C. for 12 hours prior to testing.
2.) Test Conditions and Equipment For Battery Capacity: Galvanostatic Charge/Discharge measurements should be performed on the coin cells of configuration one under the following conditions: a temperature of 30° C., a cycling rate 0.05 C (1 C=180 mAh/g), and five initial cycles at a potential window between 2.5 and 3.6 V (vs. Li⁺/Li). With temperature maintained at 30° C. and cycling rate maintained at 0.05 C, an additional 30 cycles should be conducted with a potential window of 2.5 to 3.8 V (vs. Li+/Li). Galvanostatic Charge/Discharge measurements should be performed on the coin cells of configuration 2 under the following conditions: a temperature of 60° C., a cycling rate 0.05 C (1 C=180 mAh/g), and five initial cycles at a potential window between 2.5 and 3.6 V (vs. Li⁺/Li). With temperature maintained at 60° C., the following charge and discharge cycles should be performed with a potential window of 2.5 to 3.8 V (vs. Li+/Li): 5 cycles at 0.1 C, 5 cycles at 0.3 C, 5 cycles at 0.5 C, 5 cycles at 1 C, and then 5 cycles at 0.1 C. The testing should be conducted using an 8 Channel Battery Analyzer Landt Instruments CT2001A supplied by Landt Instruments of Vestal, NY. USA or equivalent wherein said cell is in an isothermal chamber.
3,) Test Conditions and Equipment For Battery Stability Galvanostatic charge/discharge measurements should be performed for coin cell configuration 1 under the following conditions: a temperature of 30° C., a cycling rate 0.05 C (1 C=180 mAh/g), and five initial cycles at a potential window between 2.5 and 3.6 V (vs. Li⁺/Li). With temperature maintained at 30° C. and cycling rate maintained at 0.05 C, an additional 30 cycles should be conducted with a potential window of 2.5 to 3.8 V (vs. Li+/Li). For coin cell configuration two, galvanostatic charge/discharge measurements should be performed under the following conditions: a temperature of 60° C., a cycling rate 0.05 C (1 C=180 mAh/g), and five initial cycles at a potential window between 2.5 and 3.6 V (vs. Li⁺/Li). With temperature maintained at 60° C., 150 cycles at 0.3 C should be conducted with a potential window of 2.5 to 3.8 V (vs. Li+/Li). The testing is conducted using an 8 Channel Battery Analyzer (Landt Instruments CT2001A) in isothermal chamber. For configuration 2, the battery should assembled as indicated in this test method and stored at 25° C. in an uncharged state for 672 hours before being tested.

Test To Determine Battery Structure and Electrochemical Distribution of Materials in the Composite Cathode. The structure and electrochemical distribution of materials in the composite cathode is assessed with cross-sectional SEM/EDX using a Jeol, JSM-6060 from Joel of Peabody, Mass. USA or an equivalent. Prior to imaging, the composite electrode sample should be maintained at −60° C. for 12 hours (Tenny Environment Chamber). Then composite electrode sample should be cut with scissors to achieve a clear cross-sectional surface. The cut sample should then mounted on the SEM holder vertically and characterized under 10 kV with a spot size of 25.

### Examples

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: Membrane-free all solid state lithium ion battery. A LiFePO4 cathode was created by suspending LiFePO4 powder, carbon Super P, and Kynar PVDF binder in n-methyl-2-pyrrolidone. This suspension was aerosol jet printed onto a carbon-coated aluminum current collector. The cathode was dried overnight at 90° C., then calendared to 60% porosity. The solid polymer electrolyte pre-cursor ink was prepared by mixing succinonitrile, polyethylene glycol diacrylate, lithium bis(oxalate) borate, lithium bis(trifluoromethanesulphonyl) imide (LiTFSI, Matrix Scientific), photoinitiator bis(2,4,6-trimethyl benzoyl)-phenyl phosphine oxide, and fluoroethylene carbonate. The solid polymer electrolyte precursor ink was printed directly on top of the printed cathode. The printed solid polymer electrolyte pre-cursor film was then UV crosslinked. The printed cathode/solid polymer electrolyte part was then fabricated into a battery coin cell with the lithium metal anode.

Example 2: Membrane-supported all solid state lithium ion battery. A LiFePO4 cathode was created by suspending LiFePO4 powder, carbon Super P, and Kynar PVDF binder in n-methyl-2-pyrrolidone. This suspension was aerosol jet printed onto a carbon-coated aluminum current collector. The cathode was dried overnight at 90° C., then calendared to 60% porosity. The solid polymer electrolyte pre-cursor ink was prepared by mixing succinonitrile, polyethylene glycol diacrylate, lithium bis(oxalate) borate, lithium bis(trifluoromethanesulphonyl) imide (LiTFSI, Matrix Scientific), photoinitiator bis(2,4,6-trimethyl benzoyl)-phenyl phosphine oxide, and fluoroethylene carbonate. The solid polymer electrolyte precursor ink was printed directly on top of the printed cathode. The printed solid polymer electrolyte pre-cursor film was then UV crosslinked. A Solupor membrane was soaked in the solid polymer electrolyte pre-cursor ink, then UV crosslinked. The printed cathode/solid polymer electrolyte, and soaked Solupor membrane were then fabricated into a battery coin cell with the lithium metal anode.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. An all-solid-state battery comprising the following sequential layers: a current collector layer, a cathode layer, a solid polymer electrolyte layer and an anode layer, at least a portion of said solid polymer electrolyte extending through said cathode.

2. The all-solid-state battery of claim 1 wherein said solid polymer electrolyte extends through said cathode to contact said current collector.

3. The all-solid-state battery of claim 1 wherein said solid polymer electrolyte comprises crosslinked polyethylene glycol diacrylate, Bis(trifluoromethylsulfonyl) amine lithium salt, lithium bis(oxalato) borate, succinonitrile, and fluroethylene carbonate.

4. The all-solid-state battery of claim 1 wherein said solid polymer electrolyte comprises, based on solid polymer electrolyte weight, 19% polyethylene glycol diacrylate, 26% Bis(trifluoromethylsulfonyl) amine lithium salt, 20% lithium bis(oxalato) borate, 30% succinonitrile, and 5% fluroethylene carbonate.

5. The all-solid-state battery of claim 1, said all-solid-state battery having, at 30° C. a specific capacity of over 130 mAh/g at 0.05 C and area capacity is 1.37 mAh/cm².

6. The all-solid-state battery of claim 1 said all-solid-state battery having, at 60° C. test, reversible specific capacities of 163 mAh/g, 138 mAh/g, 126 mAh/g, 121 mAh/g, and 154 mAh/g at current densities of 0.1 C, 0.3 C, 0.5 C, 1 C, and 0.1 C; and reversible areal capacities of 1.6 mAh/cm², 1.35 mAh/cm², 1.23 mAh/cm², 1.19 mAh/cm² and 1.51 mAh/cm² at current densities of 0.1 C, 0.3 C, 0.5 C, 1 C, and 0.1 C.

7. The all-solid-state battery of claim 1, said all-solid-state battery having, after 150 cycles at 0.3 C at a temperature of 60° C., a capacity retention of 97.4% and 99.98% coulombic efficiency.

8. An article comprising the all-solid-state battery of claim 1, said article being a battery energy storage system, an electric vehicle, or a consumer electronic device.

9. A process of making all-solid-state batteries:
a) making an active material ink, said active ink comprising a dispersion of a cathode active, a conduct carbon, and a conductive polymer, in a solvent;
b) aerosol jet printing a cathode from said active ink on a conductive substrate said aerosol jet printing being conducted under a dew point of less than −40° C., a printing nozzle distance to said conductive substrate of 10 mm, said conductive substrate being maintained during said aerosol jet printing at a temperature of 50° C. and said active ink being maintained during said aerosol jet printing at a temperature of 21° C., said active ink being deposited on said conductive substrate at a rate of 9 mg/minute, said cathode after said aerosol jet printing having an active ink mass loading of 10 mg/cm²;
c) drying said cathode to remove said active ink solvent;
d) calendaring said cathode to a porosity of 60%;
e) aerosol jet printing a solid polymer electrolyte ink on at least one side of said cathode, said solid polymer electrolyte ink comprising crosslinked polyethylene glycol diacrylate, Bis(trifluoromethylsulfonyl) amine lithium salt, lithium bis(oxalato) borate, succinonitrile, and fluroethylene carbonate, said aerosol jet printing being conducted under a dew point of less than −40° C., a printing nozzle distance to said conductive substrate of 10 mm, said cathode being maintained during said aerosol jet printing at a temperature of 50° C. and said solid polymer electrolyte ink being maintained during said aerosol jet printing at a temperature of 40° C., said solid polymer electrolyte ink being deposited on said conductive substrate at a rate of 5 mg/minute, said aerosol jet printing comprising 25 aerosol jet printing passes;
e) UV curing said cathode; and
f) depositing an anode material on said printed solid polymer electrolyte.

10. The process of claim 9 wherein said solid polymer electrolyte comprises, based on solid polymer electrolyte weight, 19% polyethylene glycol diacrylate, 26% Bis(trifluoromethylsulfonyl) amine lithium salt, 20% lithium bis(oxalato) borate, 30% succinonitrile, and 5% fluroethylene carbonate, and said deposition comprises aerosol jet printing said anode on said printed solid polymer electrolyte.

11. The process of claim 10 wherein preferably said anode material comprises Li and/or graphite.
